(19) United States
(12) Patent Application Publication
(10) Pub. No.: US 2013/0002610 A1
(43) Pub. Date: Jan. 3, 2013

(54) TOUCH SENSITIVE DISPLAY DEVICE

(75) Inventors: HSIEN-LUNG HO, Tu-Cheng (TW); CHIU-HSIUNG LIN, Tu-Cheng (TW)

(73) Assignee: HON HAI PRECISION INDUSTRY CO., LTD., Tu-Cheng (TW)

(21) Appl. No.: 13/431,990

(22) Filed: Mar. 28, 2012

(30) Foreign Application Priority Data
Jun. 28, 2011 (TW) 100122596

(51) Int. Cl. G06F 3/042; G06F 3/045

(52) U.S. Cl. 345/175

(57) ABSTRACT

A touch display device includes an interferometric modulator display panel and a processor. The display panel includes a plurality of pixel units. The pixel units each includes a fixed mirror including a reflective surface, at least one spacer, a transmovable mirror and at least one sensor. The at least one spacer is arranged between the fixed mirror and the movable mirror, the movable mirror is spaced an adjustable distance from the fixed mirror, and the movable mirror reflects a first portion of incident light and to allow a second portion of the incident light to pass therethrough. The at least one pressure sensor is fixed on the movable mirror and senses depression of the movable mirror caused by a touch thereon. The processor determines the touch position according to the generating signals from the sensors.

### BACKGROUND

1. Technical Field

The present disclosure relates to display devices, especially to a touch sensitive interferometric modulator display device.

2. Description of Related Art

Touch sensitive displays, such as resistive and capacitive, infrared type, electrostatic inductive, have been commonly used. A touch sensitive display typically includes a display panel and a plastic substrate. Lines are arranged on the plastic substrate, and an integrated circuit is connected with the lines and a controller. The plastic substrate is integrated on the display panel. One problem with such conventional touch sensitive display is that the sensitivity of such display is limited because of the lines that cross with each other. Rather it is difficult for the display to be made thin enough to allow for miniaturization.

Therefore, what is needed is a touch sensitive display device to overcome the above mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a touch sensitive display device in accordance with an exemplary embodiment.

FIG. 2 is a schematic, cross-sectional view showing a pixel unit of the touch sensitive display device of FIG. 1 in accordance with a first exemplary embodiment.

FIG. 3 is a schematic view showing spacers of a pixel unit of the touch sensitive display device of FIG. 2.

FIG. 4 is a schematic view showing that a pixel unit of the touch sensitive display device of FIG. 2 is depressed by a user.

FIG. 5 is a cross-sectional view of a pixel unit of the touch sensitive display device of FIG. 1 in accordance with a second exemplary embodiment.

FIG. 6 is a schematic view showing that a pixel unit of the touch sensitive display device of FIG. 5 is depressed by a user.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

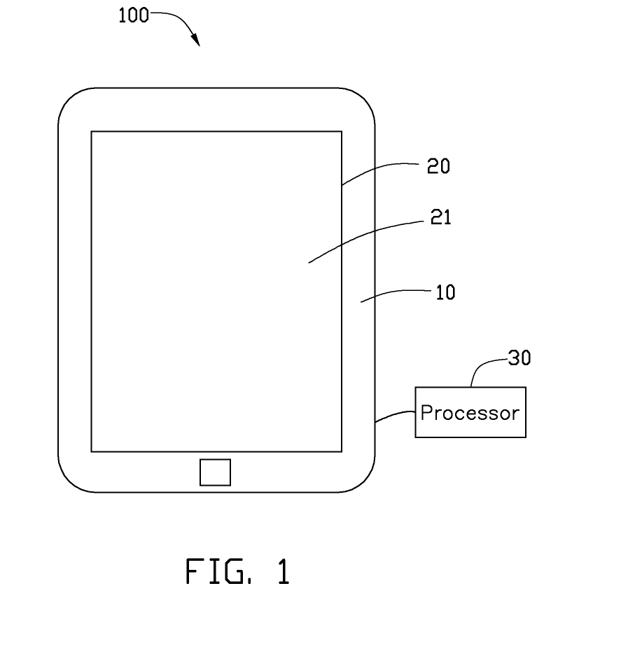

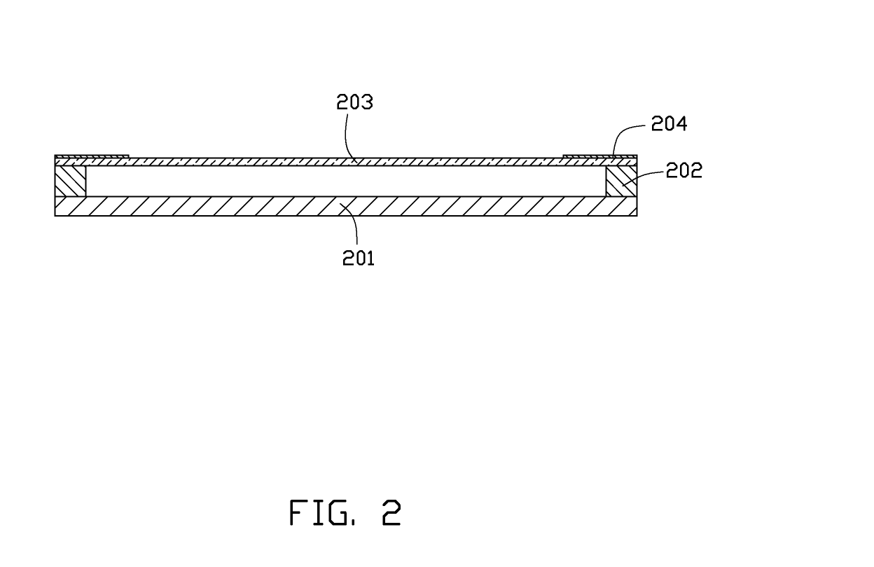

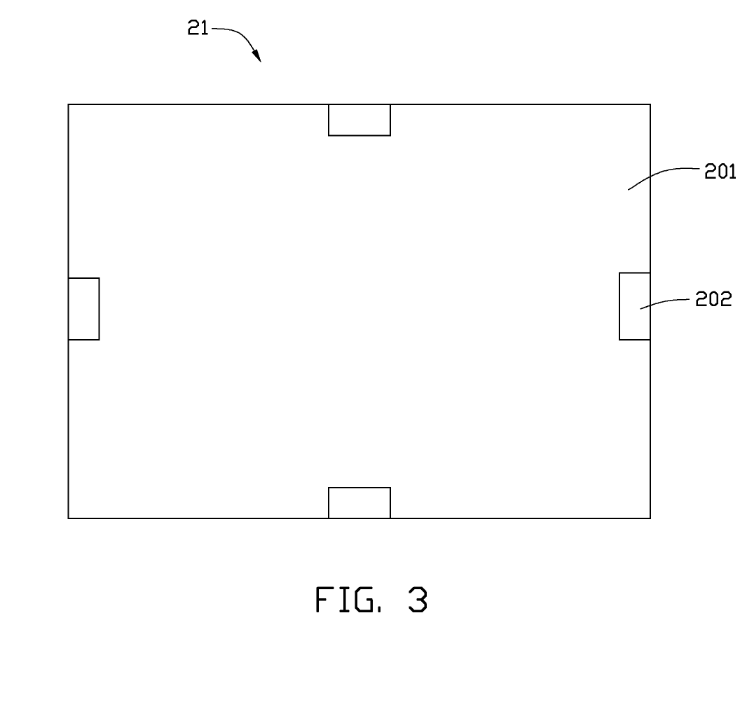

Referring to FIGS. 1-3, a touch sensitive display device 100 is illustrated. The touch display device 100 includes a housing 10, a display panel 20 and a processor 30. The display panel 20 is framed within the housing 10; the processor 30 is fixed in the housing 10 and is electrically connected to the display panel 20.

The display panel 20 is an interferometric modulator display panel and includes a plurality of pixel units 21. Each pixel unit 21 includes a substrate 201, at least one spacer 202, a reflective element 203 and at least one pressure sensor 204. The substrate 201 is a fixed mirror and the reflective element 203 is a transmovable mirror. The reflective element 203 is made of deformable, transflective membrane. In an embodiment, the reflective element 203 is an integral part of the pixel unit 21. In another embodiment, the reflective element 203 may include a number of independent reflective units, each reflective unit is placed on one pixel unit 21.

High reflection film is coated on the inner surface of the substrate 201 for reflecting light. In the embodiment, the high reflection film can be a metal reflective coating chosen from the group consisting of an aluminum coating, a gold coating and a silver coating. The reflective element 203 is spaced a variable and controllable distance from the substrate 201 by the spacers 202. The contact area of the spacers 202 with the substrate 201 and reflective element 203 is far smaller than the substrate 201 and reflective element 203 for enhancing the incidence light. A portion of incident light is reflected by the reflective element 203, and the rest of the incident light penetrates the reflective element 203 and is reflected by the substrate 201 to the reflective element 203. When the light reflected by the substrate 201 and reflective element 203 recombines, they generate interference phenomenon, causing the pixel units 21 to display a color that depends on the difference between the distances they traveled. Namely, the distance between the substrate 201 and the reflective element 203 determines the color displayed by the pixel units 21.

In the embodiment, the thickness of the spacer 202 is defined as “D”, and thus the distance between the substrate 201 and the reflective element 203 spaced by the spacer 202 is “D”. The wavelength of the incidence light is defined as “λ”. In order to form a light interference described above, the relationship of the thickness “D” of the spacer 202 and the wavelength “λ” of the incidence light needs to satisfy “2d=Nλ”, where N is natural number 1, 2, 3 . . . .

The sensor 204 is fixed on the viewing side of the reflective element 203 and is electrically connected to the processor 30. The viewing side means a side facing a user when he/she views the content displayed on the display 100. That is, the pressure sensors 204 are fixed on the side of the reflective element 203 that is opposite to the spacer 202. The pressure sensors 204 are piezoresistive or piezoelectric.

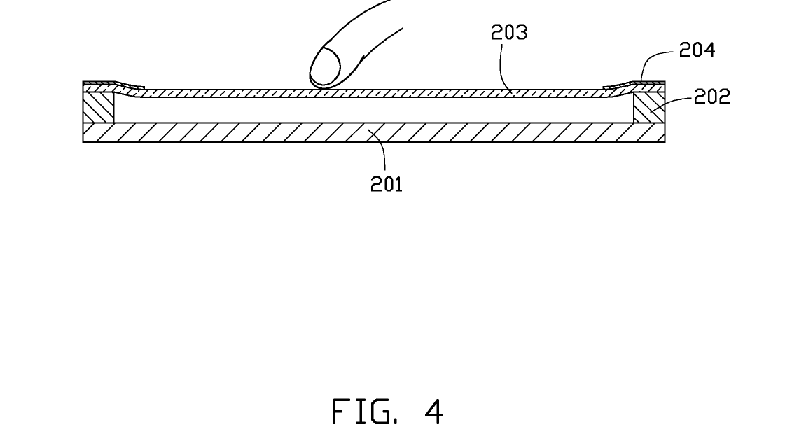

Referring to FIG. 4, when a touch from a user is applied on the reflective element 203, the reflective element 203 is deformed and further causes the pressure sensors 204 fixed on the reflective element 203 to be deformed due to reacting force from the spacer 202. The pressure sensors 204 then generate sensing signals. The processor 30 receives the sensing signals and determines which pressure sensors 204 transmit the signals to processor 30 and determines the touched pixel units 21. As a result, the processor 30 can determine a touched area/position where the user touches the display device 100.

In a first embodiment, each pixel unit 21 includes four spacers 202 and four pressure sensors 204. The four spacers 202 are fixed on four edges of the substrate 201 and abut against or support the reflective element 203. The four pressure sensors 204 are arranged on the position where the deformation of the reflective element 203 can be easily detected. In the embodiment, the pressure sensors 204 are arranged adjacent to the position where the spacers 202 and the reflective element 203 are joined. The four pressure sensors 204 are set to correspond to the pixel unit 21, that is, the processor 30 identifies one touched pixel unit 21 when any one of the four pressure sensors 204 have detected deformation. Each pixel unit 21 is assigned a coordinate value, such that the processor 30 can determine the positions of each pixel unit 21 and can determine a touched area/position based on the pixel units 21 whose pressure sensors 204 have detected deformation.

In another embodiment, the number of the spacers 202 may be two, and the spacers 202 may be fixed on substrate 201 of one pixel unit 21 at diagonal corners of the substrate 201 and abuts against or supports the reflective element 203. The number of the sensors may be two.

In another embodiment, the number of the spacers 202 may be one, and the spacer 202 may be fixed on the center of the substrate 201. The number of the pressure sensors 204 may be one and may be fixed on center of the reflective element 203.

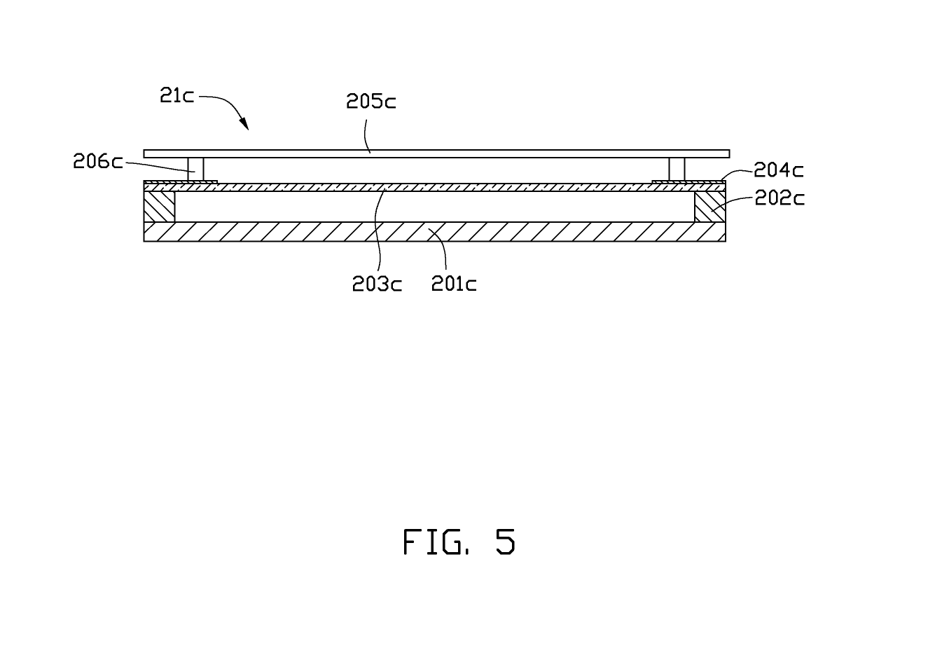

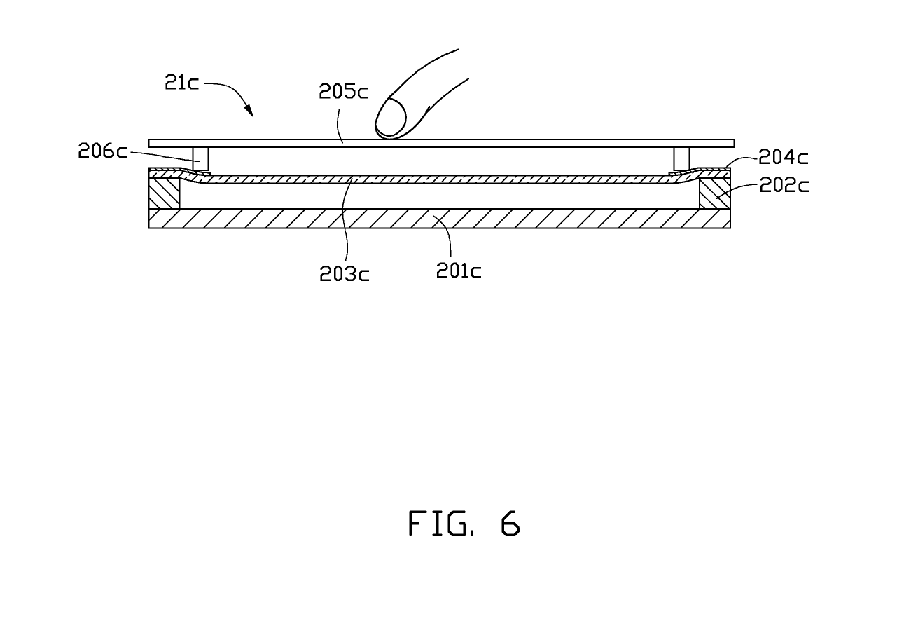

Referring to FIGS. 5-6, in a second embodiment, pixel units 21c each include a substrate 201c, four spacers 202c, a reflective element 203c, four pressure sensors 204c and a soft panel 205c. The soft panel 205c is flexible and is capable of being deformed under external force. The reflective element 203c is made of deformable, transflective membrane. The four spacers 202c are fixed on the middle of four edge of the substrate 201c. The pressure sensors 204c are fixed on the reflective element 203c and electrically connected to the processor 30. The four pressure sensors 204c are respectively arranged right above the four spacers 202c and are set to correspond to one pixel unit 21c.

The soft panel 205c is fixed on the reflectively panel 203c, and includes a number of knobs 206 residing on the pressure sensors 204c. When the soft panel 205c is depressed, the knobs 206 push the pressure sensors 204c and the pressure sensors 204c can detect the pressure from the knobs 206. With the soft panel 205c having knobs 206 on the reflective element 203c, the sensors pressure 204c can more easily detect a touch on the display device 100 because the depression from a user will be transmitted to the pressure sensors 204c through the knobs 206. In addition, the soft panel 205 can protect the reflective element 203c from being damaged because the pressure is evenly distributed to the reflective element 203c through the knobs 206.

In another embodiment, the number of the spacers 202c may be one or two, and the number of the knobs 206 of the soft board 205c and the pressure sensors 204c may correspond to the number of the spacers 202c. In this embodiment, there is at least one knobs 206 that abuts against one of the pressure sensors 204c.

If the number of the spacer 202c is one, the spacers 202c is fixed on center of the substrate 201c to support the reflective element 203c, and the number of the pressure sensors 204c is also one. The sensor pressure 204c is fixed on the center of the reflective element 203c corresponding the spacer 202c. In the embodiment, each boss 206 abuts against one sensor 204c.

If the number of the spacers 202c is two, the spacers 202c are fixed on substrate 201c at diagonal corners of the substrate 201 to support the reflective element 203c, and the number of the pressure sensors 204c is also two. The sensors 204c are fixed on reflective element 203c corresponding the spacers 202c. Each of the knobs 206 of the soft panel 205c abuts against one sensor 204c.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A touch sensitive display device comprising:
an interferometric modulator display panel comprising a plurality of pixel units, each of the pixel units comprising:
a fixed mirror including a reflective surface;
a transmovable mirror;
at least one spacer arranged between the fixed mirror and the movable mirror, the movable mirror spaced an adjustable distance from the fixed mirror, the movable mirror being configured to reflect a first portion of incident light and to allow a second portion of the incident light to pass therethrough;
at least one pressure sensor fixed on the movable mirror and configured for sensing depression of the movable mirror caused by a touch thereon, and generating a signal associated therewith; and
a processor electrically connected to the pressure sensors of the pixel units and configured to determine a touch position according to the signals from the corresponding sensors.

2. The touch sensitive display device of claim 1, wherein the adjustable distance between the fixed mirror and the movable mirror satisfies the following equation 2D=Nλ, where D represents the distance between the fixed mirror and the movable mirror, λ represents a wavelength of the incident light, and N represents a natural number.

3. The touch sensitive display device of claim 1, wherein the at least one pressure sensor is a piezoresistive sensor or a piezoelectric sensor.

4. The touch sensitive display device of claim 1, wherein the at least one spacer comprises four spacers and the at least one pressure sensor comprise four sensors; the four spacers are fixed along four edges of the fixed mirror and abuts against the movable mirror; the pressure sensors are arranged on the movable mirror and configured detecting deformation of the movable mirror.

5. The touch sensitive display device of claim 1, wherein the at least one spacer comprises two spacers and the at least one pressure sensor comprises two sensors; the spacers are fixed on the fixed mirror at diagonal corners thereof and abuts against the movable mirror; the sensors are arranged on the movable mirror and configured detecting deformation of the movable mirror.

6. The touch sensitive display device of claim 1, wherein the fixed mirror includes a reflection film chosen from the group consisting of an aluminum coating, a gold coating and a silver coating.

7. The touch sensitive display device of claim 1, wherein the at least one pressure sensor is formed on an opposite side of the movable mirror to the fixed mirror.

8. A touch sensitive display device comprising:
an interferometric modulator display panel comprising a plurality of pixel units, each of the pixel units comprising:
a fixed mirror including a reflective surface;
a transmovable mirror;
at least one spacer arranged between the fixed mirror and the movable mirror, the movable mirror spaced an adjustable distance from the fixed mirror, the movable mirror being configured to reflect a first portion of incident light and to allow a second portion of the incident light to pass therethrough; and
at least one pressure sensor fixed on the movable mirror;
a touch film attached on the interferometric modulator display panel, a plurality of protrusions extending from the touch film to contact the corresponding pressure sensors of the pixel units, the at least one pressure sensors configured for sensing depression of the corresponding protrusion caused by a touch on the touch film, and generating a signal associated therewith, and
a processor electrically connected to the pressure sensors of the pixel units and configured to determine a touch position according to the signals from the corresponding sensors.

9. The touch sensitive display device of claim 8, wherein adjustable distance between the fixed mirror and the movable mirror satisfies the following equation 2D=Nλ, where D represents the distance between the fixed mirror and the movable mirror, λ represents a wavelength of the incident light, and N represents a natural number.

10. The touch sensitive display device of claim 8, wherein the at least one pressure sensor is a piezoresistive sensor or a piezoelectric sensor.

11. The touch display device of claim 8, wherein the at least one spacer comprises four spacers and the at least one pressure sensor comprise four sensors; the four spacers are fixed along four edges of the fixed mirror and abuts against the movable mirror; the pressure sensors are arranged on the movable mirror and configured detecting deformation of the movable mirror.

12. The touch sensitive display device of claim 8, wherein the at least one spacer comprises two spacers and the at least one pressure sensor comprises two sensors; the spacers are fixed on the fixed mirror at diagonal corners thereof and abuts against the movable mirror; the sensors are arranged on the movable mirror and configured detecting deformation of the movable mirror.

13. The touch sensitive display device of claim 8, wherein the fixed mirror comprises a reflection film chosen from the group consisting of an aluminum coating, a gold coating and a silver coating.
